(19) United States
(12) Patent Application Publication
(10) Pub. No.: US 2025/0153781 A1
(43) Pub. Date: May 15, 2025

(54) JOINT STRUCTURE OF VEHICLE BODY

(71) Applicants: Hyundai Motor Company, Seoul (KR); Kia Corporation, Seoul (KR)

(72) Inventors: SuIn PARK, Hwaseong-Si (KR); Tae Han Kang, Hwaseong-Si (KR)

(73) Assignees: Hyundai Motor Company, Seoul (KR); Kia Corporation, Seoul (KR)

(21) Appl. No.: 18/812,120

(22) Filed: Aug. 22, 2024

(30) Foreign Application Priority Data
Nov. 15, 2023 (KR) 10-2023-0158489

(51) Int. Cl. B62D 27/06; B60D 1/24

(52) U.S. Cl. CPC B62D 27/06; B60D 1/246

(57) ABSTRACT

A joint structure of a vehicle body includes a driving module and a space module joined to a rear end portion of the driving module, the structure including: a fixation bar disposed at the rear end portion of the driving module; a guide member disposed at a center portion of the fixation bar, protruding to the space module, and moved forwards or backwards to the space module; a pair of extension pins formed on edge portions of the fixation bar and protruding to the space module; a guide slot which retreats from an internal center portion of the space module to an opposite side of the driving module, and into which the guide member is selectively inserted; an extension slot which is formed in an edge portion of the space module and into which the extension pin is inserted; and a motor selectively operated to fix the guide member to the guide slot while the guide member is inserted into the guide slot.

### CROSS-REFERENCE TO RELATED APPLICATION

The present application claims priority to Korean Patent Application No. 10-2023-0158489 filed on Nov. 15, 2023, the entire contents of which is incorporated herein for all purposes by this reference.

### BACKGROUND OF THE INVENTION

### Field of the Present Disclosure

The present disclosure relates to a joint structure of a vehicle body, and more particularly, to a joint structure of a vehicle body that includes a driving module (or a fixed part) and a space module (or a variable part) in a purpose built vehicle (PBV).

### Description of Related Art

An automobile industry has been recently introducing a new concept of a future mobility vision to realize a human-centered dynamic future city. One of these future mobility solutions may be a purpose built vehicle (PBV) which is a purpose-based mobility.

An example of the PBV vehicle may be an eco-friendly mobile vehicle based on an electric vehicle (EV). This PBV vehicle may provide various customized services to a user during a transport time from its origin to destination through an unmanned or manned autonomous traveling manner.

The PBV vehicle may include a cab-type driving module employing a driving device and capable of performing autonomous traveling, and a space module coupled to the driving module and used for cargo transportation, passenger use, home office, or the like.

A conventional joint method may generally use joining in a form of a ring, which may be uncomfortable as a user has to manually perform the joining. Furthermore, there is no buffer part between the driving module and the space module. In the instant case, a collision may occur due to a clearance between the two modules when the driving module suddenly starts or brakes, and up-down movement may occur, which may adversely affect ride comfort and cause the two modules to be deviated from each other.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present disclosure are directed to providing a joint structure of a vehicle body which may prevent a collision between a driving module and a space module by reducing a clearance between the two modules in front-to-back and up-down directions when fastening these two modules to each other, ensure ride comfort of a passenger boarding the space module, and may automatically fixedly fastening or separating the two modules to or from each other.

According to an exemplary embodiment of the present disclosure, provided is a joint structure of a vehicle body that includes a driving module and a space module joined to a rear end portion of the driving module, the structure including: a fixation bar disposed at the rear end portion of the driving module; a guide member disposed at a center portion of the fixation bar, protruding to the space module, and moved forwards or backwards to the space module; a pair of extension pins formed on edge portions of the fixation bar and protruding to the space module; a guide slot which retreats from an internal center portion of the space module to an opposite side of the driving module, and into which the guide member is selectively inserted; an extension slot which is formed in an edge portion of the space module and into which the extension pin is inserted; and a motor selectively operated to fix the guide member to the guide slot while the guide member is inserted into the guide slot.

Each of two sides of the guide slot may be connected to an internal side of the guide support included in the space module.

The guide slot may extend integrally to the internal side of the guide support.

The guide member may include a push pin inserted into the guide slot and moved by operation of the motor, and stem wedges in contact with the push pin and selectively coupled to an internal wall of the guide slot as the push pin is moved.

The push pin may have its central axis connected to a rotated gear member, and may be moved within the guide slot as the gear member is rotated.

The gear member may include a gear shaft movably engaged to the central axis of the push pin, and a gear head formed on one end portion of the gear shaft and engaged to the motor for transmitting a driving force of the motor to rotate the gear shaft.

The gear shaft may pass through the fixation bar, and the gear head may be disposed to be adjacent to the driving module disposed outside the fixation bar.

A motor gear, which is rotated by operation of the motor, may be disposed on a rotation shaft of the motor, and the motor gear may be joined to the gear head to transmit the driving force of the motor to the gear head.

A thread may be formed on an external peripheral surface of the gear shaft, and the thread may be joined to a thread formed on a corresponding internal peripheral surface of the push pin and operated to move the push pin according to the rotation of the gear shaft.

An end portion of the push pin may be formed in a cone shape, and an end portion of the stem wedges that corresponds to the end portion of the push pin may be formed in a shape corresponding to the shape of the end portion of the push pin.

The push pin may be moved to the stem wedges, and when the end portion of the push pin is in contact with the end portion of the stem wedges, the stem wedges may be operated to spread first and second sides thereof to an internal surface of the guide slot due to the pressure and shape of the push pin.

A step portion may be formed on an internal peripheral surface of the guide slot, and the stem wedges may be inserted into and fixed to the step portion.

A length of the step portion may be greater than a length of the stem wedges.

A base, which supports the gear shaft and limits a movement distance of the gear member within the guide slot, may be disposed on the other end portion of the gear shaft.

An elastic band, which provides an elastic force to return the stem wedges to its original position from the spread, may be wrapped around an internal peripheral surface of the stem wedges disposed on the base.

A base seating portion, on which the base is accommodated, may be disposed at an end portion of the guide slot, and a gap sensor, which detects a gap between the base and the base seating portion, may be disposed below the base seating portion.

The gap sensor may apply an electrical signal to the motor to cause the motor to be operated when the gap between the base and the base seating portion has a set value or less than the set value.

An extension protrusion portion may protrude from an end portion of the extension pin to the extension slot, and the extension protrusion portion may be inserted into the extension slot.

The extension slot may include an extension opening, a pair of extension opening supports supporting the extension opening and opposing each other, and a pair of extension pin fixation portions disposed on internal sides of the extension opening supports and gradually getting closer to each other as the extension pin fixation portion is closer to the internal side from the extension opening.

When the extension protrusion portion is inserted into the extension slot, the extension pin fixation portion may be operated to be in contact with a side portion of the extension protrusion portion and apply pressure to the side portion to thus fix the side portion.

According to the exemplary embodiments of the present disclosure, the joint structure of a vehicle body that includes the driving module and the space module joined to the rear end portion of the driving module may reduce the clearance between the two modules when the two modules are joined to each other to thus ensure the rigidity of the fastener, and prevent the collision occurring between the two modules during the sudden start or brake of the driving module.

Furthermore, the structure may simultaneously employ the guide member joining and the extension pin joining to thus fix the front-to-back or up and down movement of the vehicle, ensuring the ride comfort of the passenger boarding the space module.

Furthermore, the structure may be widely used not only in the joint method of the PBV vehicle, but also in the method of fastening the trailer and the towing vehicle to each other, and apply the automatic method rather than the manual method, providing the improved marketability.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic view showing a vehicle using a joint structure of a vehicle body according to an exemplary embodiment of the present disclosure.

FIG. 2 is a schematic view showing a driving module in portion “A” of FIG. 1.

FIG. 3 is a schematic view showing a frame structure of a space module in the joint structure of a vehicle body according to an exemplary embodiment of the present disclosure.

FIG. 4 is a schematic view showing a state where joint of the vehicle body begins in the joint structure of a vehicle body according to an exemplary embodiment of the present disclosure.

FIG. 5 is a schematic view showing a state where the joint of the vehicle body is in progress in the joint structure of a vehicle body according to an exemplary embodiment of the present disclosure.

FIG. 6 is a schematic view showing a state where the joint of the vehicle body is completed in the joint structure of a vehicle body according to an exemplary embodiment of the present disclosure.

FIG. 7 is a schematic view showing a joint relationship between a motor and a gear member in the joint structure of a vehicle body according to an exemplary embodiment of the present disclosure.

FIG. 8 is a schematic view showing a state where the joint of the vehicle body begins and the guide member begins to be inserted into a guide slot in the joint structure of a vehicle body according to an exemplary embodiment of the present disclosure.

FIG. 9 is a schematic view showing a state where the joint of the vehicle body is in progress and the guide member is inserted into the guide slot in the joint structure of a vehicle body according to an exemplary embodiment of the present disclosure.

FIG. 10 is a schematic view showing a state where the joint of the vehicle body is completed and the guide member is inserted into the guide slot in the joint structure of a vehicle body according to an exemplary embodiment of the present disclosure.

FIG. 11 is a view showing the gear member according to an exemplary embodiment of the present disclosure.

FIG. 12 is a view showing a state where a push pin is joined to the gear member according to an exemplary embodiment of the present disclosure.

FIG. 13 is a view showing a state where the push pin is joined to the gear member and stem wedges is disposed below the push pin according to an exemplary embodiment of the present disclosure.

FIG. 14 is a view showing a state where the push pin is joined to the gear member and the stem wedges is joined to the push pin according to an exemplary embodiment of the present disclosure.

FIG. 15 is a view showing a state where the push pin and the stem wedges are joined to the gear member and an elastic band is disposed below the stem wedges according to an exemplary embodiment of the present disclosure.

FIG. 16 is a view showing a state where the push pin, the stem wedges, and the elastic band are joined to the gear member according to an exemplary embodiment of the present disclosure.

FIG. 17 is a view showing a state where a base is disposed below the gear member according to an exemplary embodiment of the present disclosure.

FIG. 18 is a view showing a state where the base is joined to a bottom portion of the gear member according to an exemplary embodiment of the present disclosure.

FIG. 19 is an enlarged view showing a state where the elastic band is disposed on the gear member according to an exemplary embodiment of the present disclosure.

FIG. 20 is an enlarged view showing a state where the elastic band is joined to the gear member according to an exemplary embodiment of the present disclosure.

FIG. 21A and FIG. 21B are views each schematically showing a joint relationship between an extension pin and an extension slot in the joint structure of a vehicle body according to an exemplary embodiment of the present disclosure.

FIG. 22A and FIG. 22B are schematic views showing states before and after the extension pin is joined to the extension slot in the joint structure of a vehicle body according to an exemplary embodiment of the present disclosure.

It may be understood that the appended drawings are not necessarily to scale, presenting a somewhat simplified representation of various features illustrative of the basic principles of the invention. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the invention(s) will be described in conjunction with exemplary embodiments of the present disclosure, it will be understood that the present description is not intended to limit the invention(s) to those exemplary embodiments of the present disclosure. On the other hand, the invention(s) is/are intended to cover not only the exemplary embodiments of the present disclosure, but also various alternatives, modifications, equivalents and other embodiments, which may be included within the spirit and scope of the invention as defined by the appended claims.

Hereinafter, various exemplary embodiments of the present disclosure will be described in detail with reference to the accompanying drawings so that those skilled in the art to which the present disclosure pertains may easily practice the present disclosure. The present disclosure may be implemented in various different forms and is not limited to the exemplary embodiments described herein.

Furthermore, in several exemplary embodiments of the present disclosure, components including the same configuration will be representatively described using the same reference numerals in an exemplary embodiment of the present disclosure, and only components different from those of an exemplary embodiment will be described in the other embodiments.

It should be understood that the drawings are schematic and not drawn to scale. The size and proportion of a component in the drawings are shown relatively exaggerated or reduced in size to clearly and easily explain the drawings. This arbitrary size is only illustrative and not limitative. Furthermore, the same reference numeral is used to denote a similar feature of the same structure, element or part shown in two or more drawings. When it is described that an element is referred to as being “on” or “above” another element, it is to be understood that the element may be directly “on” another element or “above” another element including a third element interposed therebetween.

An exemplary embodiment of the present disclosure specifically represents an exemplary embodiment of the present disclosure. As a result, diagrams may be various modified. Accordingly, an exemplary embodiment of the present disclosure is not limited to a specific shape of the illustrated portion, and may include, for example, a shape modified when produced.

Hereinafter, a joint structure of a vehicle body according to an exemplary embodiment of the present disclosure is described in detail with reference to the accompanying drawings.

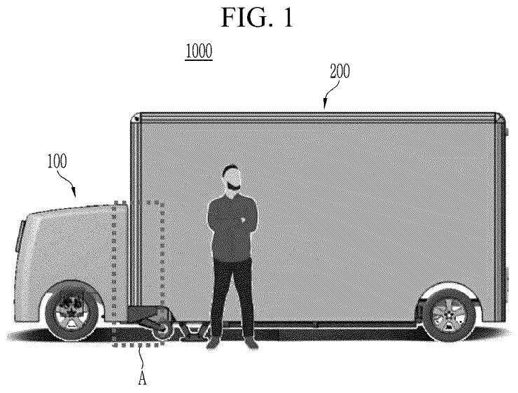

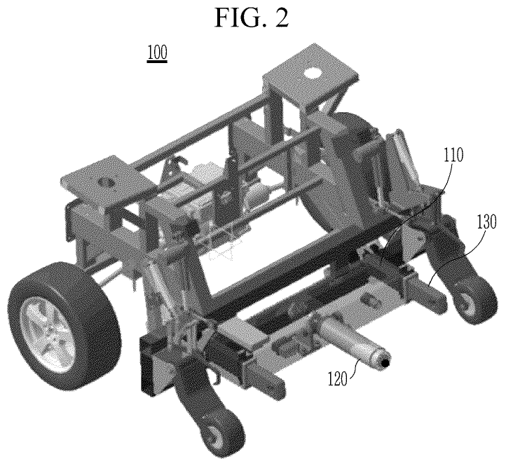

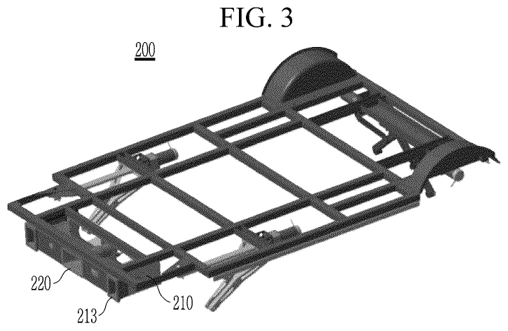

FIG. 1 is a schematic view showing a vehicle using a joint structure of a vehicle body according to an exemplary embodiment of the present disclosure; FIG. 2 is a schematic view showing a driving module in portion “A” of FIG. 1; and FIG. 3 is a schematic view showing a frame structure of a space module in the joint structure of a vehicle body according to an exemplary embodiment of the present disclosure.

Referring to FIG. 1, FIG. 2, and FIG. 3, the joint structure of a vehicle body according to an exemplary embodiment of the present disclosure may be applied to, for example, a purpose-based mobility vehicle (or a purpose built vehicle, hereinafter referred to as a “PBV vehicle”).

The PBV vehicle may be used as an electric vehicle-based life module vehicle providing various customized services to a user during a transport time from its origin to destination thereof.

A vehicle body of the PBV vehicle may be suitable for small quantity production of various vehicle types having a small number of parts, and may be manufactured in various shapes and sizes.

In an exemplary embodiment of the present disclosure, a vehicle 1000 may include a cab-type driving module 100 and a box-type space module 200 joined to the rear of the driving module 100.

Meanwhile, the present disclosure may be employed not only in the PBV vehicle configured by joining the driving module 100 and the space module 200 to each other, but also in a method of fastening a towing vehicle and a trailer to each other.

Referring to FIG. 2 and FIG. 3, in the joint structure of a vehicle body according to an exemplary embodiment of the present disclosure, the driving module 100 may include a fixation bar 110, guide members 120 and 140, and an extension pin 130. Furthermore, the space module 200 may include a guide slot 220 and an extension slot 213.

The fixation bar 110 may configure a rear end portion of the driving module 100, have a rectangular bar shape extending in a direction perpendicular to a longitudinal direction of the vehicle body, and serve as a framework of a joint portion of the driving module 100.

The guide members 120 and 140 may be disposed at a center portion of the fixation bar 110 and protrude to the space module 200. The guide members 120 and 140 may have an overall cylindrical shape which has a diameter which is smaller as being further away from the fixation bar 110. This shape may allow the guide members 120 and 140 to be inserted smoothly into the guide slot 220.

The extension pin 130 may protrude from an edge portion of the fixed bar 110 to the space module 200. The extension pin 130 may be formed in a rectangular bar shape, and the pair of extension pins 130 may be disposed on the edge portions of the fixation bar 110.

The guide slot 220 may be formed in an internal center portion of the space module 200. The guide slot 220 may be an opening in a guide support 210 of the space module 200, and may have a shape of a pincer retreating from an internal side of the space module 200 to an opposite side of the driving module 100. The guide members 120 and 140 may be inserted into the guide slot 220, and the guide slot 220 may be in contact with two external sides of the guide pin 120 or 140 to fix the guide members 120 and 140 inserted into the guide slot 220.

The pair of extension slots 213 may be disposed in edge portions of the space module 200. The pair of extension pins 130 disposed on the edge portions of the fixation bar 110 may be inserted into the extension slots 213.

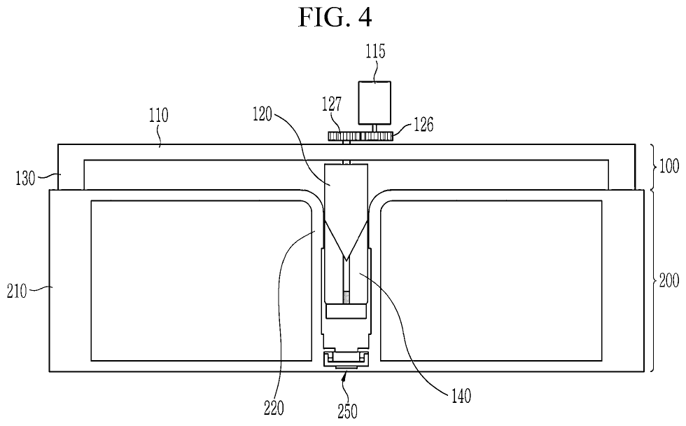

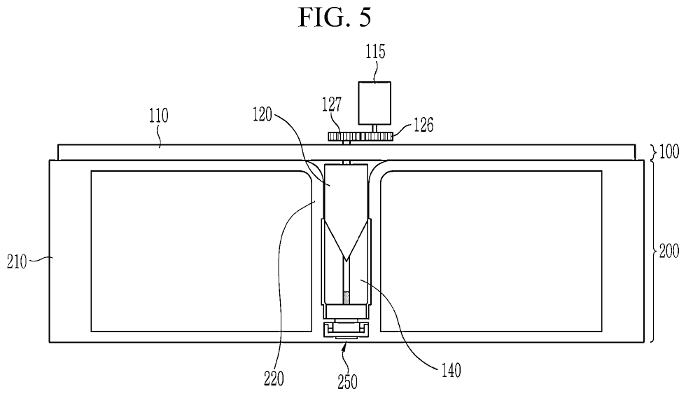

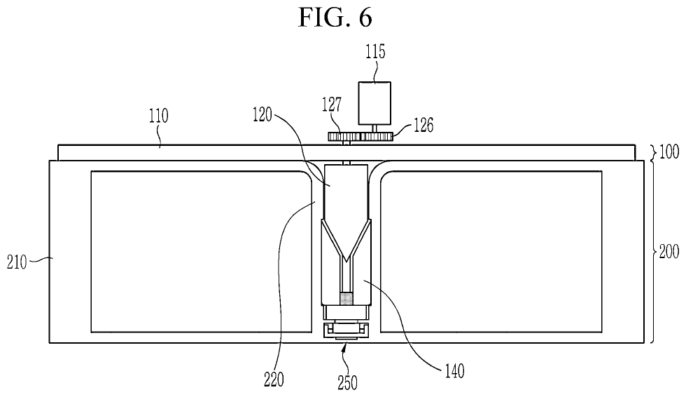

FIG. 4 is a schematic view showing a state where joint of the vehicle body begins in the joint structure of a vehicle body according to an exemplary embodiment of the present disclosure; FIG. 5 is a schematic view showing a state where the joint of the vehicle body is in progress in the joint structure of a vehicle body according to an exemplary embodiment of the present disclosure; and FIG. 6 is a schematic view showing a state where the joint of the vehicle body is completed in the joint structure of a vehicle body according to an exemplary embodiment of the present disclosure.

Referring to FIG. 4, FIG. 5 and FIG. 6, the guide slot 220 may have the shape of the pincer retreating from the internal side of the space module 200 to the opposite side of the driving module 100, and each of two end portions of the guide slot 220 may be connected to an internal side of the guide support 210 included in the space module 200.

Furthermore, the guide slot 220 may extend integrally to the internal side of the guide support 210. A central entrance portion of the guide slot 220 may have rounded corners. Therefore, the guide members 120 and 140 may be smoothly inserted into the guide slot 220.

The guide members 120 and 140 may include the push pin 120 and the stem wedges 140. When the driving module 100 is moved and joined to the space module 200, the guide members 120 and 140 may be inserted into the guide slot 220. To the present end, the guide members 120 and 140 may be joined to gear members 125 and 127, and the gear members 125 and 127 may be connected to a motor 115 disposed outside the fixation bar 110.

The push pin 120 may have its central axis connected to the gear members 125 and 127, and may be moved within the guide slot 220 as the gear members 125 and 127 are rotated. The gear members 125 and 127 may include the gear shaft 125 and the gear head 127. The gear shaft 125 may pass through the fixation bar 110 to be installed therein, extend to the space module 200, and be rotatably joined to the central axis of the push pin 120 or the stem wedges 140. Furthermore, the gear head 127 may be fixedly joined to one end portion of the gear shaft 125, and disposed to be adjacent to the driving module 100 disposed outside the fixation bar 110 to be connected to the motor 115.

The motor 115 is disposed to be adjacent to the driving module 100, and a motor gear 126, which is rotated by operation of the motor 115, may be disposed on a rotation shaft of the motor 115. A driving force of the motor 115 may be transmitted to the gear head 127 to thus rotate the gear shaft 125 when the motor gear 126 is joined to the gear head 127 to operate the motor 115.

As shown in FIG. 5, the driving module 100 may be moved and joined to the space module 200 to thus sufficiently insert the guide members 120 and 140 into the guide slot 220, operating the motor 115. The operation of the motor 115 may be performed by a gap sensor 250. The gap sensor 250 may be disposed at an internal end portion of the guide slot 220, face end portions of the guide member 120 or 140, and detect proximity of the guide members 120 and 140. The motor 115 may begin the operation when the gap sensor 250 detects that the guide members 120 and 140 are sufficiently inserted into the guide slot 220.

As shown in FIG. 6, when the motor 115 is operated, the motor gear 126 may be rotated to thus rotate the gear head 127 joined to the motor gear 126. The rotation of the gear head 127 may rotate the gear shaft 125, and the push pin 120 joined to the gear shaft 125 may be moved to the stem wedges 140 within the guide slot 220.

When the push pin 120 is moved to the stem wedges 140 while the stem wedges 140 is not moved, the stem wedges 140 may naturally spread its two sides to an internal surface of the guide slot 220 due to shapes of the push pin 120 and the stem wedges 140.

An end portion of the push pin 120 may be formed in a cone shape, and an end portion of the stem wedges 140 that corresponds to the end portion of the push pin 120 may be formed in a shape corresponding to the shape of the end portion of the push pin 120.

The stem wedges 140 may come into contact with the internal surface of the guide slot 220 while having sufficient pressure by the sufficient pressure that the push pin 120 pushes to the stem wedges 140, which may be configured to generate friction. As a result, the driving module 100 and the space module 200 may be securely fixed to each other.

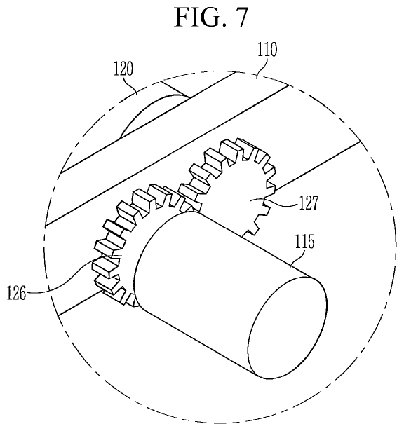

FIG. 7 is a schematic view showing a joint relationship between the motor and the gear member in the joint structure of a vehicle body according to an exemplary embodiment of the present disclosure.

As shown in FIG. 7, the motor 115 may be disposed to be adjacent to the driving module 100 disposed outside the fixation bar 110, and the motor gear 126 may be joined to the rotation shaft of the motor 115. The motor gear 126 may be disposed between the motor 115 and the fixation bar 110. The gear head 127 may be joined to the motor gear 126 disposed outside the fixation bar 110. The gear shaft 125 may be joined to the gear head 127, pass through the fixation bar 110, and extend to the space module 200. When the shaft of the motor 115 and the motor gear 126 are rotated by operation of the motor 115, the gear head 127 joined to the motor gear 126 may be rotate to thus rotate the gear shaft 125. The gear shaft 125 may be formed of threads on an external surface thereof and push pin 120 may be formed of threads on an internal hole thereof so that the rotation of the gear shaft 125 may cause the push pin 120 to be moved straight to an internal surface of the guide slot 220.

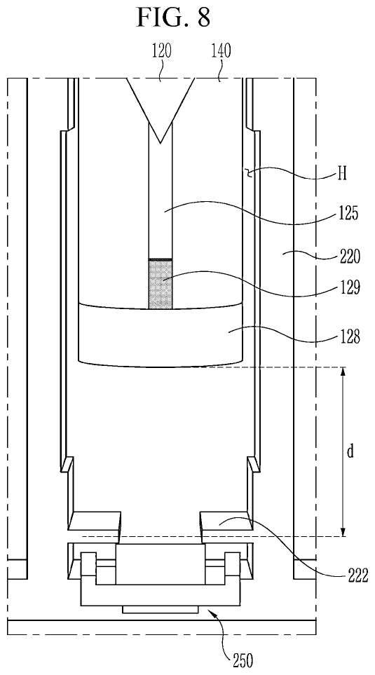

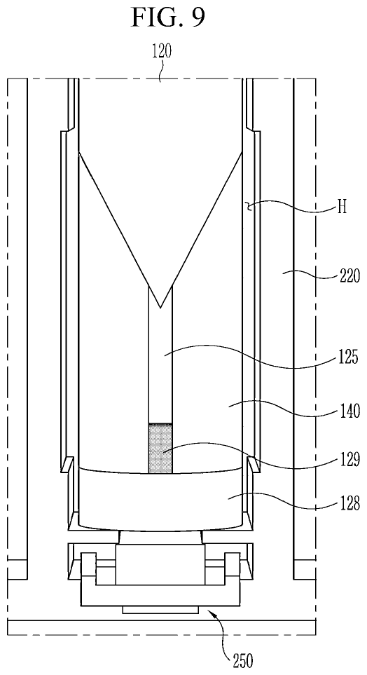

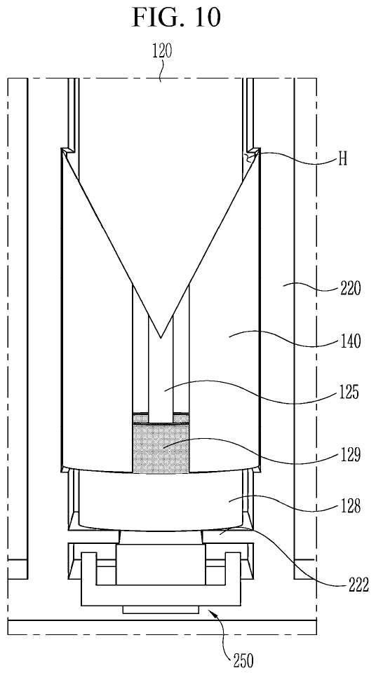

FIG. 8 is a schematic view showing a state where the joint of the vehicle body begins and the guide member begins to be inserted into the guide slot in the joint structure of a vehicle body according to an exemplary embodiment of the present disclosure; FIG. 9 is a schematic view showing a state where the joint of the vehicle body is in progress and the guide member is inserted into the guide slot in the joint structure of a vehicle body according to an exemplary embodiment of the present disclosure; and FIG. 10 is a schematic view showing a state where the joint of the vehicle body is completed and the guide member is inserted into the guide slot in the joint structure of a vehicle body according to an exemplary embodiment of the present disclosure.

A base 128, which supports the gear shaft 125 and limits movement distances of the gear members 125 and 127 within the guide slot 220, may be disposed on the other end portion of the gear shaft 125.

Furthermore, a base seating portion 222, on which the base 128 is accommodated, may be disposed at the end portion of the guide slot 220, and the gap sensor 250, which detects a gap “d” between the base 128 and the base seating portion 222, may be disposed below the base seating portion 222.

The gap sensor 250 may apply an electrical signal to the motor 115 to cause the motor 115 to be operated when the gap “d” between the base 128 and the base seating portion 222 has a set value or less than the set value.

Meanwhile, an elastic band 129, which provides an elastic force to return the stem wedges 140 to its original position from the spread, may be wrapped around an internal peripheral surface of the stem wedges 140 disposed on the base 128.

Furthermore, a step portion H may be formed on an internal peripheral surface of the guide slot 220, and the stem wedges 140 may be inserted into and fixed to the step portion H.

As shown in FIG. 8, the driving module 100 may be moved and joined to the space module 200. Accordingly, the guide members 120 and 140 may be inserted into the guide slot 220, and the gap sensor 250 may detect the gap “d” between the base 128 and the base seating portion 222.

As shown in FIG. 9, the motor 115 may be operated and the gear shaft 125 may thus begin to be rotated when the guide members 120 and 140 are sufficiently inserted into the guide slot 220 and the base 128 and the base seating portion 222 are in contact with each other (here, the predetermined value of the gap “d” may be zero).

As shown in FIG. 10, the rotation of the gear shaft 125 may move the push pin 120, and the push pin 120 may press the stem wedges 140. Accordingly, the two sides of the stem wedges 140 may spread to the internal surface of the guide slot 220 to be in contact with and fixed to the internal surface of the guide slot 220. The stem wedges 140 may be inserted into and fixed to the step portion H formed on the internal peripheral surface of the guide slot 220, and the present fixation may assist the friction between the stem wedges 140 and the guide slot 220 to ensure for the guide members 120 and 140 to be prevented from being deviated from the guide slot 220.

Meanwhile, a contact sensor may also be used instead of the gap sensor 250. The contact sensor may detect whether the base 128 is in contact with the base seating portion 222, and operate the motor 115 when detecting the contact.

The driving module 100 may be separated from the space module 200, and the guide members 120 and 140 may be removed from the guide slot 220. In the instant case, the removal may be performed in a reverse order of the process described with reference to FIG. 8, FIG. 9 and FIG. 10. That is, when the motor 115 is operated to rotate the shaft of the motor 115 in an opposite direction, the push pin 120 may be moved to an opposite side of the stem wedges 140, and the elastic band 129 may provide the elastic force to return the stem wedges 140 to its original position thereof. Accordingly, the stem wedges 140 may be released from its fixation to the step portion H formed on the internal peripheral surface of the guide slot 220 and released from its contact with the internal surface of the guide slot 220. Furthermore, the gear shaft 125 may be continuously rotated by operation of the motor 115 to thus remove the guide members 120 and 140 from the guide slot 220.

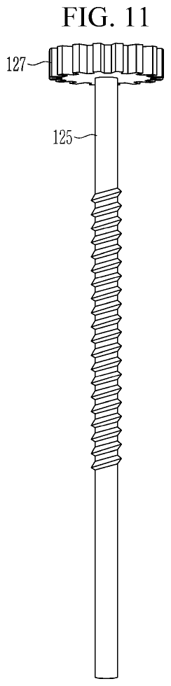

FIG. 11 is a view showing the gear member according to an exemplary embodiment of the present disclosure.

Referring to FIG. 11, the gear members 125 and 127 may include the gear shaft 125 movably joined to the central axis of the push pin 120 and the gear head 127 disposed on one end portion of the gear shaft 125. A thread may be formed on an external peripheral surface of a center portion of the gear shaft 125, and the thread may be joined to a thread formed on a corresponding internal peripheral surface of the push pin 120. When the gear shaft 125 is rotated, the push pin 120 may be moved straight by a rotation of the thread of the push pin 120 which is joined to the thread of the gear shaft 125.

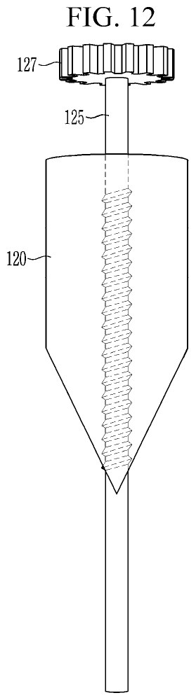

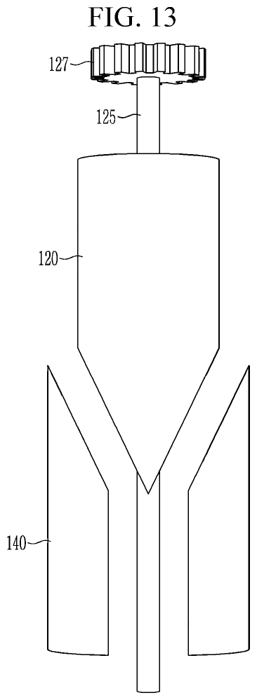

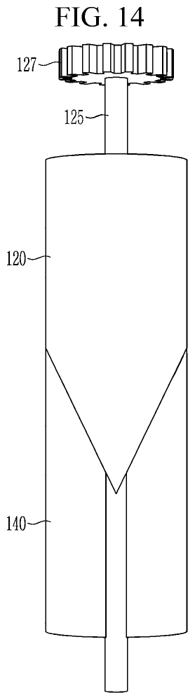

FIG. 12 is a view showing a state where the push pin is joined to the gear member according to an exemplary embodiment of the present disclosure; FIG. 13 is a view showing a state where the push pin is joined to the gear member and the stem wedges is disposed below the push pin according to an exemplary embodiment of the present disclosure; and FIG. 14 is a view showing a state where the push pin is joined to the gear member and the stem wedges is joined to the push pin according to an exemplary embodiment of the present disclosure.

As shown in FIG. 12, the push pin 120 may be screwed to the external peripheral surface of the gear shaft 125 of the gear members 125 and 127. Furthermore, as shown in FIGS. 13 and 14, the stem wedges 140 may be disposed below the push pin 120 and joined to the gear shaft 125. Each of the pair of stem wedges 140 may be provided while including a shape corresponding to an end shape of the push pin 120.

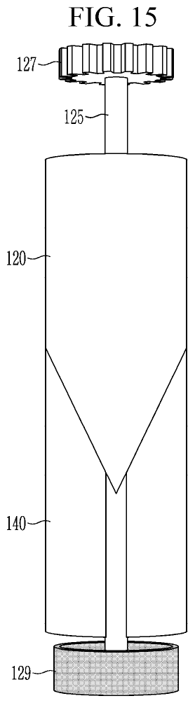

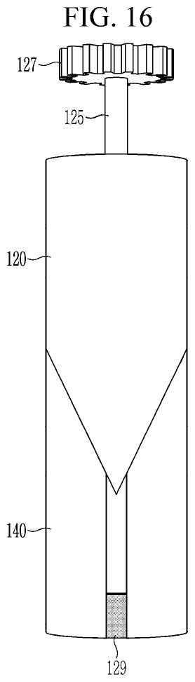

FIG. 15 is a view showing a state where the push pin and the stem wedges are joined to the gear member and the elastic band is disposed below the stem wedges according to an exemplary embodiment of the present disclosure; and FIG. 16 is a view showing a state where the push pin, the stem wedges, and the elastic band are joined to the gear member according to an exemplary embodiment of the present disclosure.

As shown in FIG. 15 and FIG. 16, the elastic band 129 may be formed in an annular shape and provided on the internal peripheral surface of the stem wedges 140. The elastic band 129 may be made of a rubber material.

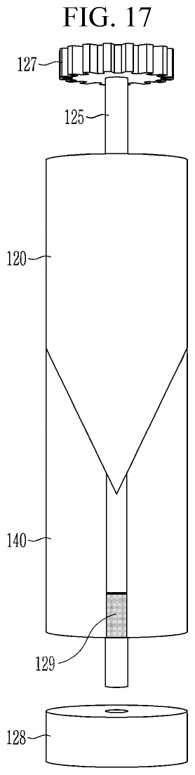

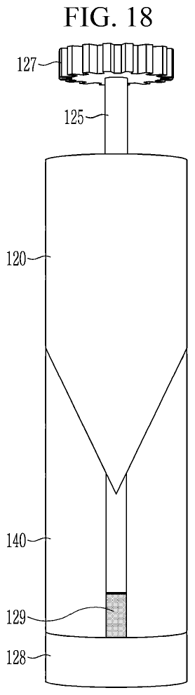

FIG. 17 is a view showing a state where the base is disposed below the gear member according to an exemplary embodiment of the present disclosure; and FIG. 18 is a view showing a state where the base is joined to a bottom portion of the gear member according to an exemplary embodiment of the present disclosure.

As shown in FIG. 17 and FIG. 18, the base 128 may be disposed on the other end portion of the gear shaft 125. The base 128 may prevent the gear members 125 and 127 from being moved excessively within the guide slot 220, and be in contact with the base seating portion 222 within the guide slot 220, limiting its movement distance. The base seating portion 222 may be disposed below the elastic band 129.

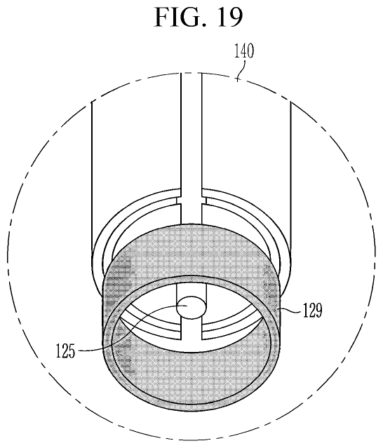

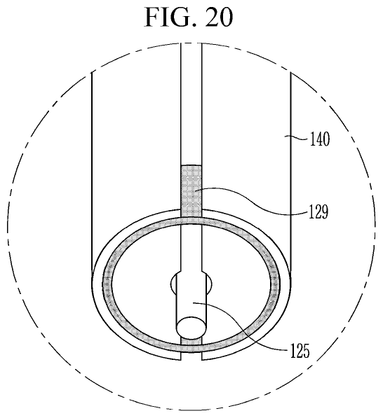

FIG. 19 is an enlarged view showing a state where the elastic band 129 is disposed on the gear member according to an exemplary embodiment of the present disclosure; and FIG. 20 is an enlarged view showing a state where the elastic band is joined to the gear member according to an exemplary embodiment of the present disclosure.

As shown in FIG. 19 and FIG. 20, the elastic band 129 may be disposed at the end portion of the stem wedges 140, and fitted to an internal surface of the stem wedges 140. That is, half-moon shaped plates may each be installed at a lower end portion of the stem wedges 140, and the elastic band 129 may be fitted and fixed to a space between the plate and the internal surface of the stem wedges 140 for the elastic band 129 to maintain its annular shape without being deviated from the stem wedges 140.

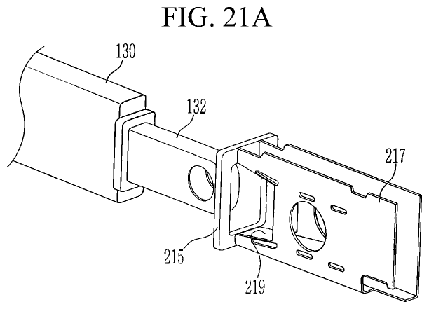

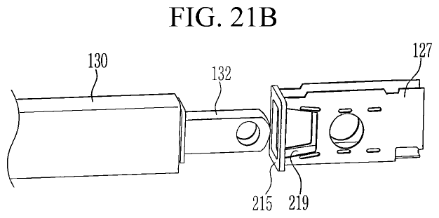

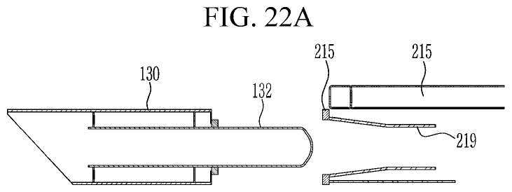

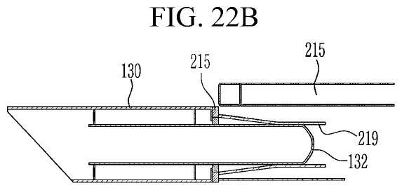

FIG. 21A and FIG. 21B are views each schematically showing a joint relationship between an extension pin and an extension slot in the joint structure of a vehicle body according to an exemplary embodiment of the present disclosure; and FIG. 22A and FIG. 22B are schematic views showing states before and after the extension pin is joined to the extension slot in the joint structure of a vehicle body according to an exemplary embodiment of the present disclosure.

Referring to FIGS. 21A, 21B, 22A and 22B, an extension protrusion 132 may protrude from an end portion of an extension pin 130 to an extension slot 213, and the extension protrusion 132 may be inserted into the extension slot 213.

The extension slot 213 may include an extension opening 215 which is an entrance into which the extension pin 130 is inserted, a pair of extension opening supports 217 supporting the extension opening 215 and opposing each other, and a pair of extension pin fixation portions 219 disposed on internal sides of the extension opening supports 217 and gradually getting closer to each other as the extension pin fixation portion is closer to the internal side from the extension opening 215.

When the extension protrusion 132 is inserted, the extension pin fixation portion 219 may be operated to be in contact with a side portion of the extension protrusion 132 and apply pressure to the side portion to thus fix the same. The extension pin fixation portions 219 may have a cone shape in which the extension pin fixation portions 219 gradually get closer to each other as being moved to an internal side of the extension slot 213, and have elastic forces for the extension protrusion 132 to return to its original position when the extension protrusion 132 is removed from the extension slot 213.

According to the exemplary embodiments of the present disclosure, the joint structure of a vehicle body that includes the driving module and the space module joined to a rear end portion of the driving module may reduce the clearance between the two modules when the two modules are joined to each other to thus ensure the rigidity of the fastener, and prevent the collision occurring between the two modules during the sudden start or brake of the driving module.

Furthermore, the structure may simultaneously employ the guide member joining and the extension pin joining to thus fix the front-to-back or up and down movement of the vehicle, ensuring the ride comfort of the passenger boarding the space module.

Furthermore, the structure may be widely used not only in the joint method of the PBV vehicle, but also in the method of fastening the trailer and the towing vehicle to each other, and apply the automatic method rather than the manual method, providing the improved marketability.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the invention to the precise forms disclosed, and obviously many modifications and variations are possible in light of the above teachings. The exemplary embodiments were chosen and described to explain predetermined principles of the invention and their practical application, to enable others skilled in the art to make and utilize various exemplary embodiments of the present disclosure, as well as various alternatives and modifications thereof. It is intended that the scope of the invention be defined by the Claims appended hereto and their equivalents.

What is claimed is:

1. A joint structure of a vehicle body that includes a driving module and a space module joined to a rear end portion of the driving module, the structure comprising:
a fixation bar disposed at the rear end portion of the driving module;
a guide member disposed at a center portion of the fixation bar, protruding to the space module, and moved forwards or backwards to the space module;
a pair of extension pins formed on edge portions of the fixation bar and protruding to the space module;
a guide slot which retreats from an internal center portion of the space module to an opposite side of the driving module, and into which the guide member is selectively inserted;
an extension slot which is formed in edge portions of the space module and into which the extension pins are inserted; and
a motor enagged to the guide member and selectively operated to fix the guide member to the guide slot while the guide member is inserted into the guide slot.

2. The structure of claim 1, wherein each of first and second sides of the guide slot is connected to an internal side of the guide support included in the space module.

3. The structure of claim 2, wherein the guide slot extends integrally to the internal side of the guide support.

4. The structure of claim 1, wherein the guide member includes:
a push pin inserted into the guide slot and moved by operation of the motor, and
at least one stem wedge in contact with the push pin and selectively coupled to an internal wall of the guide slot as the push pin is moved.

5. The structure of claim 4,
wherein the guide member further includes a rotated gear member engaged to the motor, and
wherein the push pin has its central axis connected to the rotated gear member, and is moved within the guide slot as the rotated gear member is rotated by the motor.

6. The structure of claim 5, wherein the rotated gear member includes:
a gear shaft movably engaged to the central axis of the push pin, and
a gear head formed on a first end portion of the gear shaft and engaged to the motor for transmitting a driving force of the motor to rotate the gear shaft.

7. The structure of claim 6,
wherein the gear shaft passes through the fixation bar and rotatably engaged to the fixation bar, and
wherein the gear head is disposed to be adjacent to the driving module disposed outside the fixation bar.

8. The structure of claim 7, further including a motor gear,
wherein the motor gear, which is rotated by operation of the motor, is mounted on a rotation shaft of the motor, and
wherein the motor gear is engaged to the gear head to transmit the driving force of the motor to the gear head.

9. The structure of claim 6,
wherein a thread is formed on an external peripheral surface of the gear shaft, and
wherein the thread is engaged to a thread formed on a corresponding internal peripheral surface of the push pin and operated to move the push pin according to the rotation of the gear shaft.

10. The structure of claim 4,
wherein an end portion of the push pin is formed in a cone shape, and
wherein an end portion of the at least one stem wedge that corresponds to the end portion of the push pin is formed in a shape corresponding to the shape of the end portion of the push pin.

11. The structure of claim 10,
wherein the push pin is selectively movable to the at least one stem wedge, and
wherein in response that the end portion of the push pin is in contact with the end portion of the at least one stem wedge, the at least one stem wedge is operated to spread a side thereof to an internal surface of the guide slot due to pressure and shape of the push pin.

12. The structure of claim 4,
wherein the guide slot includes a step portion formed on an internal peripheral surface of the guide slot, and
wherein the at least one stem wedge is selectively inserted into and fixed to the step portion.

13. The structure of claim 12, wherein a length of the step portion is greater than a length of the at least one stem wedge.

14. The structure of claim 6, wherein a base, which supports the gear shaft and limits a movement distance of the gear member within the guide slot, is formed on a second end portion of the gear shaft.

15. The structure of claim 14, further including an elastic band wrapped around an internal peripheral surface of the at least one stem wedge disposed on the base and configured for providing an elastic force to the at least one stem wedge to return the at least one stem wedge to a original position of the the at least one stem wedge from a spreaded state of the at least one stem wedge.

16. The structure of claim 14,
wherein a base seating portion, on which the base is accommodated, is formed at an end portion of the guide slot, and
wherein a gap sensor, which detects a gap between the base and the base seating portion, is disposed below the base seating portion.

17. The structure of claim 16, wherein the gap sensor is configured to apply an electrical signal to the motor to cause the motor to be operated in response that the gap between the base and the base seating portion has a set value or less than the set value.

18. The structure of claim 1, further including:
an extension protrusion portion protruding from an end portion of the extension pins to the extension slot,
wherein the extension protrusion portion is inserted into the extension slot.

19. The structure of claim 18, further including:
a pair of extension opening supports and a pair of extension pin fixation portions,
wherein the extension slot includes an extension opening,
wherein the pair of extension opening supports supports the extension opening and opposes each other, and
wherein the pair of extension pin fixation portions is disposed on internal sides of the extension opening supports and gets closer to each other as the extension pin fixation portions are closer to the internal sides from the extension opening.

20. The structure of claim 19, wherein in response that the extension protrusion portion is inserted into the extension slot, the extension pin fixation portions are operated to be in contact with a side portion of the extension protrusion portion and applies pressure to the side portion to thus fix the side portion.
